(19) United States
(12) Patent Application Publication
(10) Pub. No.: US 2005/0278734 A1
(43) Pub. Date: Dec. 15, 2005

(54) Method for time-sensitive delivery of on-screen television programming information

(75) Inventors: Brent David Franklin, Round Rock, TX (US); Dustin Kirkland, Austin, TX (US); Liliana Orozco, Del Valle, TX (US); Christopher Hoang Doan, Austin, TX (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/855,756

(22) Filed: May 27, 2004

(51) Int. Cl. H04N 5/445; G06F 3/00; H04N 7/025

(52) U.S. Cl. 725/32; 725/135

(57) ABSTRACT

The present invention provides a method to display time-segmented descriptions of events that have happened in a currently airing television program. In this invention, the program is divided into segments. The present invention generates a description of the events that occur in each time segment. Each time segment will have a unique time designation that will identify the time range for that segment.

### FIELD OF THE INVENTION

The present invention relates to a method for delivering on-screen information about currently showing television programs and in particular to a method for providing current description information about the events that already occurred in a currently showing television program.

### BACKGROUND OF THE INVENTION

Current television systems such as satellite and cable systems provide the viewer with numerous types of information. The viewer can search programming schedules for certain programs that interest that particular viewer. In addition to accessing certain programming schedules, some systems provide a summary description of the contents of a program. In many television systems, the viewer can access this information by pressing an ‘INFO’ or ‘GUIDE’ button on the television remote control. The remote sends a signal that activates the routine that can display information about programs for the current channel of the television. With programming information, the viewer can learn when program will air and what will be the contents of that program. Some systems provide for interactive activities, which include video games that are played over the television set.

However, with all of the information that is currently available, if a person misses the start of a program, the only way for that person to learn about the previous events of that particular program is to have someone else tell them. Imagine it is 10 minutes after the hour and a viewer is flipping through the channels on the television. The viewer finds a program that looks interesting, but it started at the top of the hour. The viewer is interested in this program, but wants to know what has happened in the first ten minutes of the program. The ‘INFO’ button on the television remote provides a broad overview of the entire show, but this broad overview does not really provide information on the plot of the story to the current point in the story when the viewer began to watch. The viewer needs a detailed synopsis of the storyline since the beginning of the program.

In addition, if the viewer has to leave during a program for some reason, in many cases, the viewer will want to know what happen while they were gone. The viewer can record the show and view the missed portion at some other time. This option does not seem very desirable to a viewer nor does it solve the immediate problem of informing the viewer of the events that occurred while the viewer was absent. First, some viewers may not have blank tapes, VCRs, DVDs or digital video recorders. Additionally, the viewer would have to view the recording. Time constraints may not allow the viewer time to view their recording. Some television satellite service providers have features that allow the viewer to pause the television program until they return. In this case, a digital video recording inside the satellite or cable receiver actually records the program and enables the viewer to view the program staring at the point that the viewer stopped watching the program. In another case, if some one else is watching the program, that person could inform the viewer of the events that occurred during the viewer's absence. However, a second viewer may not exist from which the absent viewer can learn of the missed events.

Many cable and satellite services provide on-screen programming information, including a brief synopsis about the currently airing program. However, the brief synopsis gives only a broad summary about the program. When a viewer tunes in late to a program, this brief synopsis does not provide sufficient information for the viewer to catch up on what has transpired to that point. Not having this knowledge increases the likelihood that the viewer will choose to view some other program. As a result, the broadcaster of a particular program could lose a potential viewer.

Much of the information concerning television programming is made available to users upon request of that user. This information helps the user make informed decisions about viewing television programs. There remains a need for a means that can provide to a viewer an up to the minute summary of the past events of a particular program while that program is airing.

### SUMMARY OF THE INVENTION

It is an objective of the present invention to provide a method for displaying time-sensitive information about the contents of a television program that is currently airing.

It is a second objective of the present invention to provide a segmented description of the events that occur in a television program. Each segment will contain a description of the events that occurred during that time segment of the program.

It is a third objective of the present invention to provide a method that will be able to access the segmented program descriptions and display for the viewer, the segmented descriptions of the program up to the program segment that is currently being aired.

It is a fourth objective of the present invention to provide a method to simultaneously display on the television screen the segmented program descriptions along with the presently occurring program scenes.

The present invention provides a method to display time-segmented descriptions of events that have happened in a currently airing television program. In this invention, the program is divided into to segments. The present invention generates a description of the events that occur in each time segment. Each time segment will have a unique time designation that will identify the time range for that segment. For example, a designation of six (6) in the time segment could identify a time range that is the fourth through the sixth (6^{th}) minutes of the program. This time segment would contain a description of the events that occur during the 4^{th} through 6^{th} minutes of the program. The segment lengths can vary depending of the length of the program or the segment lengths can be determined based on other arbitrary reasons.

In the method of the present invention, there can be a generation or retrieval of a script for the television program. This script will not be available for live events. The next step is to determine the time interval for each description segment. The preferred length for each segment would be an equal length. However, depending of the composition of a particular program, it may be desirable to have unequal time interval for the description segments. The program transcript is divided into the defined time segments. Each time segment receives a number indicating the interval in the program covered by this segment. When a viewer desires to view the past events of the program, they can activate the process of the present invention. This process will determine the segment of the program that is airing at the time of the viewer request. The process will retrieve the first time segment description. The process will then determine if airing of this time segment is complete. If this time segment airing is complete, the process will display this segment description for review by the viewer. The program will then move to the next time segment and repeat the same process. When the process retrieves a time segment that has not completely aired, the process will terminate and not display that description. The method of the present invention will only display program descriptions for time segments that have completed airing.

### DESCRIPTION OF THE DRAWINGS

FIG. 1 is an illustration of a format for information on a particular television program list.

FIG. 2 is an illustration of a guide containing various television programs and program descriptions.

FIG. 3 is a technical illustration of the architecture of a television subscriber network.

FIG. 4 is an illustration of the segment descriptions for a television program in accordance with the present invention.

FIG. 5 is an illustration of television screen configuration displaying television programming and segment descriptions in accordance with the present invention.

FIG. 6 is an illustration of an alternative television screen configuration displaying television programming and segment descriptions in accordance with the present invention.

FIG. 7 is an illustration of the fundamental steps in method for creating a segmented program description record in accordance with the present invention.

FIG. 8 is an illustration of the detailed steps in the implementation of one embodiment of the method of the present invention in which the viewer receives segment descriptions from the beginning of the program.

FIG. 9 is an illustration of the detailed steps in the implementation of one embodiment of the method of the present invention in which the viewer receives segment descriptions from a point of the program defined by the viewer.

### DETAILED DESCRIPTION OF THE INVENTION

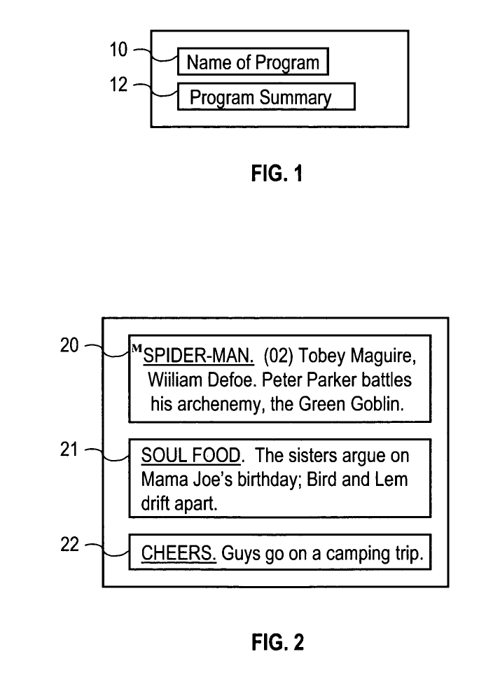

The present invention describes a method and system for providing information about the events that have transpired during a presently airing television program. Referring to FIG. 1, shown is a typical layout for a television program description. Printed television guides usually contain this type of format. The format has a location 10 for the name of the program and a program description area 12. Some formats of this type contain a notation indicating the type of program such as a movie, news or comedy program. Also, the format can contain a notation indicating the length of the program.

FIG. 2 is an illustration of a typical guide containing various television programs and program descriptions. As shown, program 20 is designated as a movie. The title indicates the name of the move. The (02) designation is year that the move was made and released. The description contains the names of the main characters in the movie. Also included in this description is a sentence about the plot of the movie. FIG. 2 also shows, the other television shows 21 and 22 with the same format. These program descriptions follow the same format illustrated in FIG. 1. Some program descriptions also contain the length of the program. Based on the type of program information that is conveyed in a typical program description illustrated in FIG. 2, the viewer that turns to a program after the program has started would not have much information to inform them of the current location of the program within the storyline or the events that have already occurred.

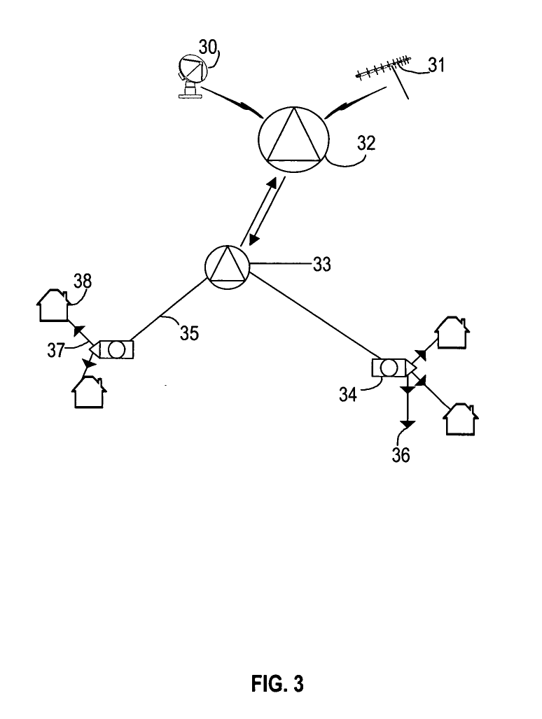

The information shown in FIGS. 1 and 2 are representative of information that is normally found in a printed television guide. Some cable and satellite systems make this information available for display via the television set. This type of information is available because of the configurations of these cable and satellite television networks. FIG. 3 is a technical illustration of the architecture of a television subscriber network. This network comprises a satellite feed 30 and off-air programming 31 that feeds into a headend 32 connected intermediate hubs 33 and then eventually to nodes 34 in each neighborhood. Fiber optics 35 connects all these elements. As distribution amplifier 36 keeps the signal at a proper or required level as it travel through the network. Coaxial cables 37 connect the nodes 34 to the end subscriber 38. The nodes 34 contain active devices that convert the fiber optic signals to RF signals for delivery over existing coaxial cable. This network architecture has enabled the provision of two-way services and has greatly increased the reliability and quality of the signal offered over the system.

The two-way services capability enables viewers to submit requests for certain programming information. In some systems, a viewer can simply press a key on the remote control connected to the receiver in the viewer's home. This receiver is connected to the local node 34. When a viewer makes a request, this request is received at the node or hub locations. Software at these locations processes the request and sends the requested information to the viewer. In the case of a program inquiry, the pressing of a guide button on the remote will send a signal containing a programming request that consists of listing the programs on a particular channel for a designated time period. This information would be sent to the viewer and would appear on the viewer's screen.

With regard to the present invention, a viewer wanting updates of the program could press a button on the remote that would send a program update request. This request would be processed and the requested information would be sent to and displayed on the viewer's television screen.

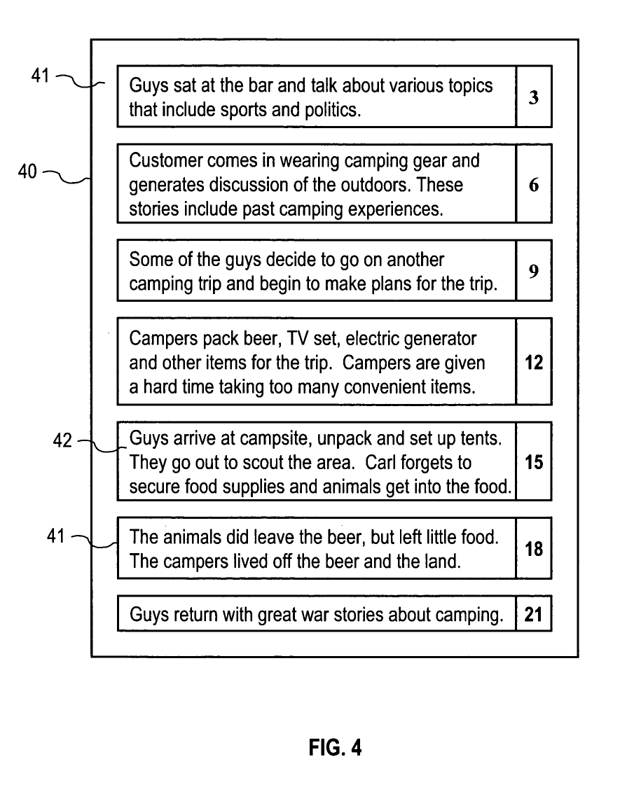

FIG. 4 is an illustration of the segment descriptions for a television program that could be displayed to a viewer in accordance with the present invention. In this television program description 40, each segment could be contained in a record 41. Each record would comprise two fields, a description field 42 and a time segment field 43. The description field would contain the text for that segment of the program. The time segment field contains a numerical designation for a time range that the description will cover. In the first record of FIG. 4, ‘Guys sat at the bar and talk about various topics that include sports and politics’ is the text description for the events that occurred in the first three minutes of the program. The record ‘Campers pack beer, TV set . . . ’ is the text description for the events through minutes 10 through 12. Since 30-minute television programs are usually 22 minutes long, the last segment could cover the entire last description segment.

Someone dividing the program into segments of predetermined length could comprise the segmented program description shown in FIG. 4. Movie programs are usually longer than other types of television programs. As a result, the segment interval for a movie may be longer than for a shorter program. The assembler would review the program or program transcript and generate written summaries for each segment of the program. Each program segment would be tagged with a designation for that segment. These time designations would be similar of the time segments shown in FIG. 4. The networks producing the television programs could also produce the program descriptions in accordance with the present invention. This process could be similar to the present process used to produce close caption information for display on televisions. In addition, a television network could transmit this information in the same manner as closed caption. The program descriptions could be stored locally or at some network location. In addition, the program descriptions could be sent to the local television service providers the same day or a designated amount of time before the programs airs. Each program will be in a temporary location and deleted at the completion of the airing of the program.

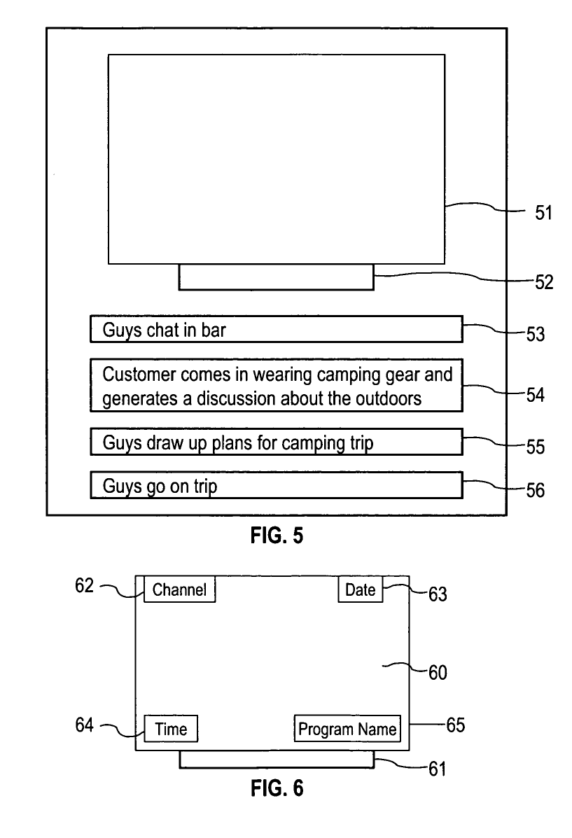

FIG. 5 is an illustration of television screen configuration displaying television programming and segment descriptions in accordance with the present invention. In this display 50, the television screen is divided into the picture section 51 and the program description section. The picture section would be the picture of the currently showing television program. The reduced picture size allows for the display of the program description on the screen. The program description section would comprise a program identification 52 and the segment updates 53, 54, 55 and 56. The program update display could contain additional information such as the current time, the channel of the program, the amount of time remaining in the program and date.

FIG. 6 is an illustration of an alternative television screen configuration displaying television programming and segment descriptions in accordance with the present invention. This approach would be similar to the implementation of closed caption text in which the text information would scroll across a section 61 at the bottom of the screen 60. In addition, other information could display at the edges of the screen in a manner similar the information display process for a video recorder. This information could include the program channel 62, the date 63, the time 64 and the program name 65. With this display embodiment, a program segment description would appear for a predetermined time interval before moving to the next segment description. At the completion of the segment descriptions, the entire display would vanish as the process ends.

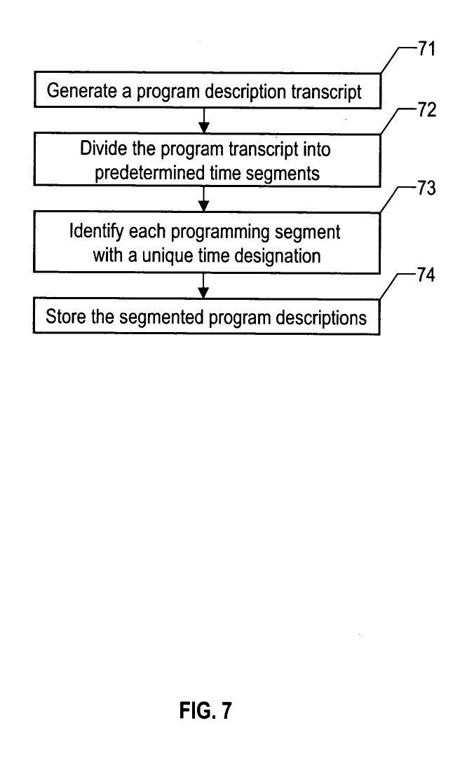

FIG. 7 is an illustration of the fundamental steps in the method for creating a segmented program description record in accordance with the present invention. This process would produce a segmented program description record such as the one illustrated in FIG. 4. The initial step 71 in this method is to generate a television program description transcript. This transcript could be a summary description of the events in every scene in the program. After generating this description transcript, step 72 divides the transcript into segments. These segments division can be arbitrary. One segment division could be time as shown in FIG. 4. Another segment division could be based on the scenes in the program. Present invention can have program description segments that vary in length or time. However, there must be mechanisms to accommodate the various segment lengths. Step 73 identifies each segment with a unique time designation and arranges the generated program segment descriptions in the preferred order. For example, referring to FIG. 4, this step ensures that the second segment in the time sequence follows first segment and that the third segment directly follows the second segment. If the segments were not arranged in proper order, the display sequence would produce a program update that is confusing to the viewer. The display may go from the description of scene one to a description of scene four with no mention of the contents of scenes two or three. Step 74 would store this generated record of FIG. 4 in a designated location.

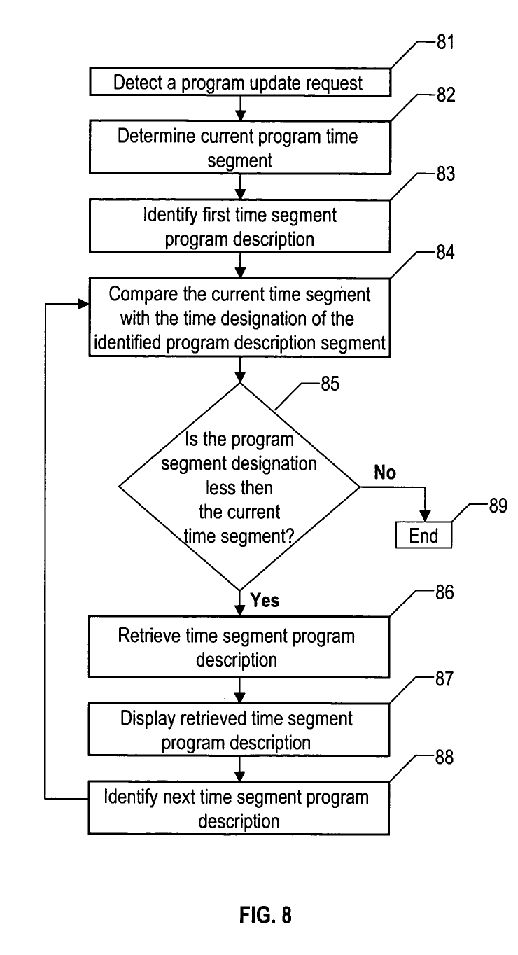

FIG. 8 is an illustration of the detailed steps in the implementation of one embodiment of the method of the present invention in which the viewer receives segment descriptions from the beginning of the program. In this method, step 81 detects a program update request. As mentioned, this request could be initiated by the viewer pressing a key on the remote control that would send a unique signal via the viewer's receiver to the television service location containing the process of the present invention. After detecting this update request, step 82 determines the program identity and determines the current time segment of the program. Depending on the particular implementation, the program identity can be contained in the signal sent by the viewer. For example, the program identity would be the program currently displaying on the viewer's television. When the signal is received, the signal information would indicate the channel for which the viewer requesting the update information. The method would then use this information to determine the program for which the viewer is making the request. Step 82 would then determine the current time segment of the program. This process is simply determining the amount of time that has elapsed since the beginning the start of the program. Once the current time segment is determined, the process can identify and retrieve all previous time segment descriptions. Referring to FIG. 4, if the update request came in the 11 minute of the program, the current time segment would be segment 4 ‘Campers pack beer, TV set . . . ’. At this time, there are three completed time segments.

Referring again to FIG. 8, step 83 identifies the first completed time segment in the list. Step 84 compares the current time segment number with the time segment number of the first time segment. Based in this comparison, step 85 determines whether the time of the first time segment is less than the time designation of the current segment. If the time segment designation is less than the time segment designation of the current time segment, the process moves to step 86, which retrieves and sends that time segment description to the viewer. Step 87 displays the time segment description in a manner such as described in FIGS. 5 and 6. Step 88 identifies the next time segment in the list and the process returns to step 84. Referring to step 85, if the time segment designation is not less than the time segment designation of the current time segment, then the viewer has received updates from all of the completed time segments. At this point, the process terminates in step 89. In the present invention, the viewer can not receive descriptions from the currently airing segment or any future time segment.

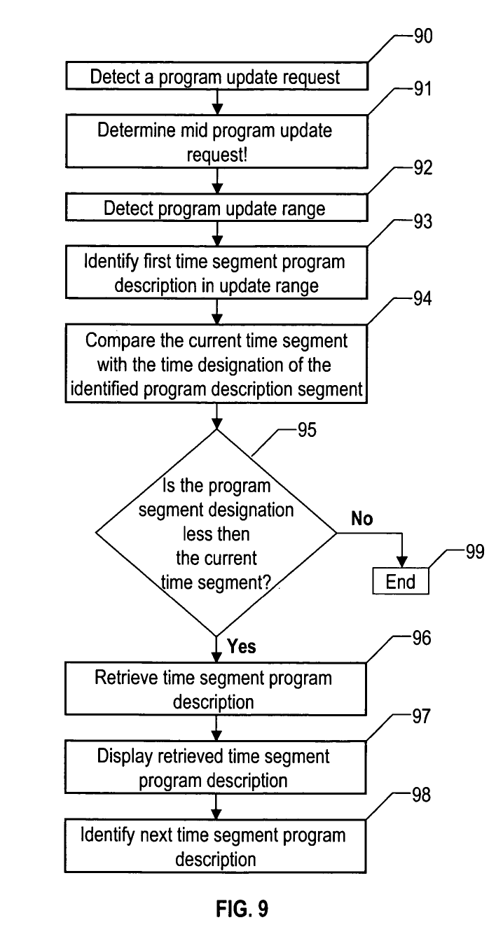

FIG. 9 is an illustration of the detailed steps in the implementation of one embodiment of the method of the present invention in which the viewer receives segment descriptions from a point of the program defined by the viewer. This method anticipates the case when an interruption causes the viewer to temporarily stop viewing a program for some reason. There may be case when a situation has developed that requires the viewer's immediate attention. When the viewer returns to the program, the viewer will want to know what has happen while the viewer was away. Because the viewer probably started watching the program from the beginning, it is not necessary update the viewer on all of the events that have already happened. The viewer only desires update from the time of the interrupt to the viewer's return.

In step 90, the method detects a program update request. Again, the method of the present invention can be implemented in a manner that will allow a different process to indicate that the update request is for a segment of the program that does not go all the way back to the program start. One approach may be to have an on-screen menu activated by the remote to give the option of updates from the start of the program or updates from a mid place in the program. If the viewer selects the mid place program update, the viewer could be prompted to enter the start time of the update. Step 91 would detect the start time designation. The end time would be the present time of the program. With the start and end times known, step 92 determines the number of time segments for this update. Step 93 identifies the first completed time segment of the list that is in the range designated by the viewer. Step 94 compares the current time segment number with the time segment number of the first time segment. Based in this comparison, step 95 determines whether the time of the first time segment is less than the time designation of the current segment. If the time segment designation is less than the time segment designation of the current time segment, the process moves to step 96, which retrieves and sends that time segment description to the viewer. Step 97 displays the time segment description in a manner such as described in FIGS. 5 and 6. Step 98 identifies the next time segment in the list and the process returns to step 94. Referring to step 95, if the time segment designation is not less than the time segment designation of the current time segment, then the viewer has received updates from all of the completed time segments. At this point, the process terminates in step 99. In the present invention, the viewer can not receive descriptions from the currently airing segment or any future time segment.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A method for time-sensitive delivery of on-screen television programming information comprising the steps of:
receiving a prompt for an update of a currently airing program;
identifying the time that has elapsed in the currently airing program;
determining whether an identified segment of the program has aired; and
displaying that identified description to the viewer when the determination is that that segment of the has already aired.

2. The method as described in claim 1 further comprising before said prompt receiving step, the step of generating a segmented description of a program.

3. The method as described in claim 2 wherein said segment description generating step further comprises the steps of:
generating a program description transcript;
dividing the program description into segments;
marking each program segment with a unique identifier;
arranging the segments in a defined order in a program record; and
storing the record of the segmented program description.

4. The method as described in claim 3 wherein said dividing step further comprises dividing the program descriptions into time segments, each segment having a unique time designation.

5. The method as described in claim 4 wherein said determination step further comprises the steps of:
identifying the current time segment of a program;
identifying a time segment description in the program record;
comparing the time designation of the identified segment description with the current time segment of the program;
determining whether the time designation of the identified segment description is less than the current time segment; and
indicating that the time segment has been aired when the determination is that the identified segment description if less than the current time segment.

6. The method as described in claim 5 further comprising after said displaying step, the steps of identifying the next time segment in the program record and returning to said comparing step.

7. The method as described in claim 4 wherein said identifying segment description step further comprises identifying the first description segment in the record.

8. The method as described in claim 5 wherein said prompt receiving step further comprising receiving an indication that the update request is a mid program update request.

9. The method as described in claim 8 further comprising the step of determining the program update range.

10. The method as described in claim 9 further comprising the step of identifying the first program description segment in the determined update range.

11. A computer program product in a computer readable medium for time-sensitive delivery of on-screen television programming information comprising:
instructions for receiving a prompt for an update of a currently airing program;
instructions for identifying the time that has elapsed in the currently airing program;
instructions for determining whether an identified segment of the program has aired; and
instructions for displaying that identified description to the viewer when the determination is that that segment of the has already aired.

12. The computer program product as described in claim 11 further comprising before said prompt receiving instructions, instructions for generating a segmented description of a program.

13. The computer program product as described in claim 12 wherein said segment description generating instructions further comprise:
instructions for generating a program description transcript;
instructions for dividing the program description into segments;
instructions for marking each program segment with a unique identifier;
instructions for arranging the segments in a defined order in a program record; and
instructions for storing the record of the segmented program description.

14. The computer program product as described in claim 13 wherein said dividing instructions further comprise instructions for dividing the program descriptions into time segments, each segment having a unique time designation.

15. The computer program product as described in claim 14 wherein said determination instructions further comprise:
instructions for identifying the current time segment of a program;
instructions for identifying a time segment description in the program record;
instructions for comparing the time designation of the identified segment description with the current time segment of the program;
instructions for determining whether the time designation of the identified segment description is less than the current time segment; and
instructions for indicating that the time segment has been aired when the determination is that the identified segment description if less than the current time segment.

16. The computer program product as described in claim 15 further comprising after said displaying instructions, instructions for identifying the next time segment in the program record and returning to said comparing instructions.

17. The computer program method as described in claim 14 wherein said identifying segment description instructions further comprise instructions for identifying the first description segment in the record.

18. The computer program product as described in claim 15 wherein said prompt receiving instructions further comprise instructions for receiving an indication that the update request is a mid program update request.

19. The computer program product as described in claim 18 further comprising instructions for determining the program update range.

20. The computer program product as described in claim 19 further comprising instructions for identifying the first program description segment in the determined update range.
